(19) United States
(12) Patent Application Publication
(10) Pub. No.: US 2013/0105333 A1
(43) Pub. Date: May 2, 2013

(54) Binary Metallic Alloys for Electro Oxidation in Alkaline Media and Method of Making Same

(71) Applicants: Barr Halevi, Albuquerque, NM (US); Timothy Olson, Arvada, CO (US); Svitlana Pylypenko, Arvada, CO (US); Abhaya Datye, Albuquerque, NM (US); Plamen B. Atanassov, Santa Fe, NM (US); Ulises Martinez, Albuquerque, NM (US)

(72) Inventors: Barr Halevi, Albuquerque, NM (US); Timothy Olson, Arvada, CO (US); Svitlana Pylypenko, Arvada, CO (US); Abhaya Datye, Albuquerque, NM (US); Plamen B. Atanassov, Santa Fe, NM (US); Ulises Martinez, Albuquerque, NM (US)

(21) Appl. No.: 13/808,687

(22) PCT Filed: Jul. 7, 2011
(86) PCT No.: PCT/US11/43241

§ 371 Date: Jan. 7, 2013

Related U.S. Application Data
(60) Provisional application No. 61/399,115, filed on Jul. 7, 2010.

(51) Int. Cl. B01J 23/80; G01N 27/26

(52) U.S. Cl. CPC B01J 23/80; G01N 27/26
USPC 205/780.5; 502/300; 502/337; 502/339; 502/343; 502/329

(57) ABSTRACT

Novel catalytic materials and methods for producing the same are shown and described. The present disclosure provides catalytic materials formed from producing an alloy of an oxophilic metal and a metal having electro-oxidative activity using spray pyrolysis. The present disclosure further provides methods and mechanisms for both detecting and removing hydrazine from a system.

### CROSS-REFERENCE TO RELATED APPLICATIONS

The following application claims benefit of U.S. Provisional Application No. 61/399,115, filed Jul. 7, 2010, which is hereby incorporated by reference in its entirety.

### STATEMENT REGARDING GOVERNMENT SPONSORED RESEARCH

This invention was made with Government support under grants Basic Energy Science—DE-FG02-05ER15712 and Epscor—DE-PS02-08ER08-04 awarded by the U.S. Department of Energy. The U.S. Government has certain rights in this invention.

### BACKGROUND

There is a great desire to find alternative methods of energy generation. To this end, technologies like fuel cells, which rely on electro-oxidation of various fuels by catalysts, are becoming increasingly popular. However, because the traditional catalysts typically are formed from or include expensive materials (like platinum group or rare earth metals for example), there is a strong desire to make catalysts that are more efficient and or/that include less expensive materials.

The use of alkaline media for electrochemical reactions presents a number of advantages over acidic environments. Most importantly, the alkaline medium offers a less corrosive environment that enables the use of non-Pt group metals (PGM) such as Palladium and Zinc as electrocatalysts, which are more abundant and significantly less expensive than PGM. Moreover, it has been shown that oxidation and reduction kinetics can be improved in alkaline media. See e.g., A. V. Tripkovic et al., “Methanol electrooxidation on supported Pt and PtRu catalysts in acid and alkaline solutions,” Electrochimica Acta 47 (22-23), 3707-3714 (2002).

Electro-oxidation of alcohols in alkaline media is a possible avenue for energy generation with a number of advantages including the ability to make alcohols from renewable feed stocks and ease of integration of alcohol-based fuels with current petroleum-based transportation fuel distribution systems.

Alternatively, electro-oxidation of hydrazine, such as occurs in direct hydrazine fuel cells (DHFC) is another application for oxidation reactions in alkaline environments. DHFCs were mainly investigated in the 1960s and 1970s. Hydrazine can be considered a green fuel source because it does not produce CO or CO2 as it is oxidized meaning that DHFCs will not suffer from CO poisoning. See e.g., George E. Evans and Karl V. Kordesch, “Hydrazine-Air Fuel Cells: Hydrazine-air fuel cells emerge from the laboratory,” Science 158 (3805), 1148-1152 (1967); Stewart Karp and Louis Meites, “The Voltammetric Characteristics and Mechanism of Electrooxidation of Hydrazine,” The Journal of the American Chemical Society 84 (6), 906-912 (1966); A. Serov and C. Kwak, “Direct hydrazine fuel cells: A review,” Appl Catal B-Environ 98 (1-2), 1-9 (2010). The desired reaction for the complete hydrazine oxidation in alkaline media is the 4-electron transfer:

N₂H₄+4OH—→N₂+4H₂O+4e- [1]

The power generation performance for hydrazine oxidation has been reported to be similar to that of hydrogen. See e.g., Koichiro Asazawa et al., “A Platinum-Free Zero-Carbon-Emission Easy Fuelling Direct Hydrazine Fuel Cell for Vehicles,” Angewandte Chemie International Edition 46 (42), 8024-8027 (2007). Early research determined that hydrazine is both highly toxic and mutagenic. See e.g., R. F. Kimball, “The mutagenicity of hydrazine and some of its derivatives,” Mutation Research/Reviews in Genetic Toxicology 39 (2), 111-126 (1977). The toxicity concerns of using hydrazine have been reduced by using a detoxification technique in which hydrazine is stored as hydrazone or hydrazide and released when required by the addition of a solvent making hydrazine a promising clean fuel for direct liquid fuel cells. See e.g., Koichiro Asazawa et al., cited above.

In addition to the advantages provided by the use of alkaline media, binary and/or ternary metal systems have been known to provide stability, increased reactivity and functionality of many catalytic systems. See e.g., Johannes Schwank, “Bimetallic catalysts: Discoveries, concepts, and applications. By John H. Sinfelt, John Wiley & Sons, 1983. XI+164 pp,” AIChE Journal 31 (8), 1405 (1985); Marc T. M. Koper, “Electrocatalysis on bimetallic and alloy surfaces,” Surface Science 548 (1-3), 1-3 (2004). The enhanced activity provided by intermetallic catalytic systems has been attributed to two different mechanisms: the bifunctional effect, which is due to a synergetic contribution of each of the elements towards a particular reaction, and the ligand or electronic effect, where the electronic properties of each element are altered by their neighboring atoms. Accordingly, because bimetallics are at times known to be more active catalysts than their pure components, it is possible that alloying Pd or other metals having oxidative activity with a less expensive metal could retain or enhance catalytic activity while reducing catalyst cost.

### SUMMARY

According to various embodiments the present disclosure provides novel catalytic materials and methods for producing the same. According to a first embodiment, the present disclosure provides catalytic materials formed from producing an alloy of an oxophilic metal and a metal having electro-oxidative activity, using spray pyrolysis. The present disclosure further provides methods and mechanisms for both detecting and removing hydrazine from a system.

### BRIEF DESCRIPTION OF THE DRAWINGS

FIG. 1 is a schematic illustration of an exemplary spray pyrolysis set-up.

FIG. 2 is an SEM micrograph of bimetallic particles after reduction.

FIG. 3 is an XRD diagram of unsupported NiZn catalysts.

FIG. 4A is a TEM micrograph of Ni_{0.50}Zn_{0.50}. Bar is 100 nm.

FIG. 4B is a TEM micrograph of Ni_{0.80}Zn_{0.20}. Bar is 100 nm.

FIG. 5A shows RDE data for the oxidation of hydrazine for different Ni solid solutions in 1M KOH.

FIG. 5B shows onset potentials for the oxidation of hydrazine for different Ni solid solutions in 1M KOH.

FIG. 6A is a top view of the most stable predicted binding geometries of hydrazine on Ni(111)

FIG. 7 depicts the ordered L1₀ phase of Ni_{0.50}Zn_{0.50}. Green: Ni; Violet: Zn; Blue: N; White: H.

FIG. 8 shows RDE data for the oxidation of ethanol for different Ni solid solutions in 1M KOH.

FIG. 9 is an XRD diagrams of unsupported PdZn catalysts.

FIG. 10 shows RDE data for the oxidation of ethanol for different PdZn alloys in 1M KOH.

FIG. 11 shows onset potential for oxidation of ethanol for different PdZn alloys in 1M KOH.

### DETAILED DESCRIPTION

According to various embodiments the present disclosure provides novel catalytic materials and methods for producing the same. According to a first embodiment, the present disclosure provides catalytic materials formed from producing an alloy of an oxophilic metal and a metal having electro-oxidative activity, using spray pyrolysis.

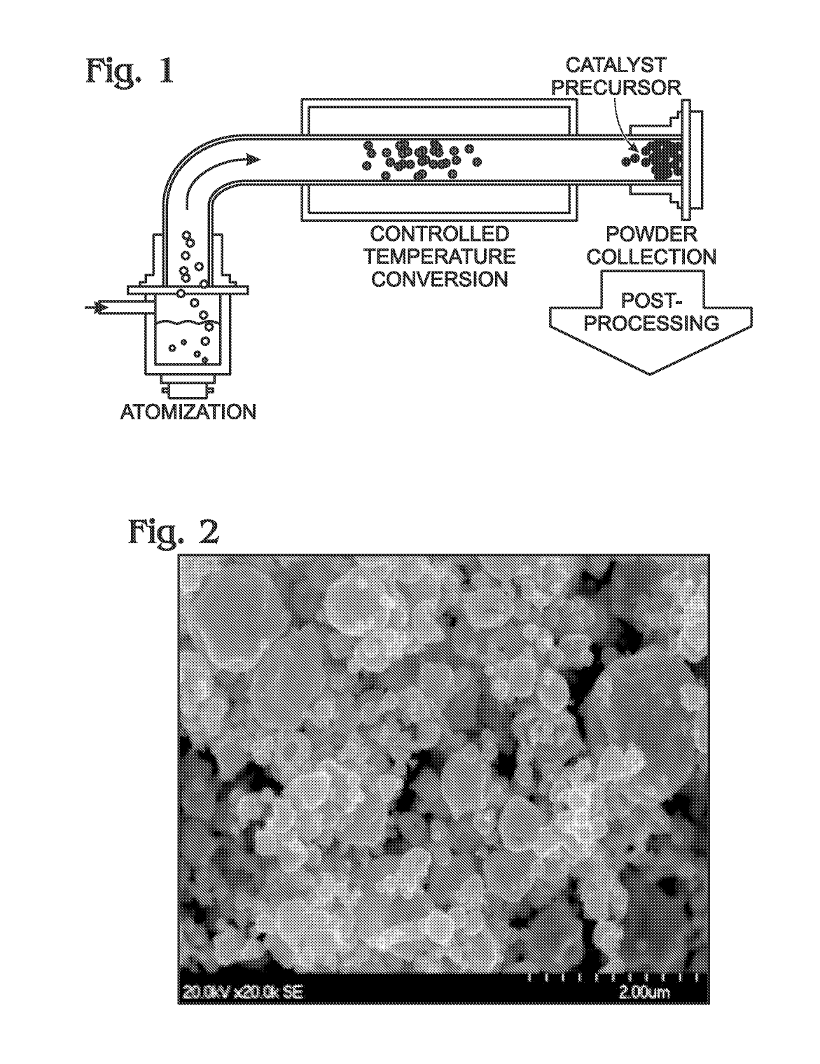

Spray pyrolysis is a materials synthesis technique that allows for thermally driven processes to occur in aerosolized droplets containing a precursor while the dispersion of such micron-sized liquid droplets is being carried in a laminar flow through a controlled temperature hot-wall reactor/furnace (FIG. 1). Typically, though not necessarily, the precursor is a solution containing oxides of the desired metals dissolved in an acidic solution. One advantage of the presently described method is that the oxides can be dissolved in the solution at a specific stoichiometric ratio. This ratio is maintained throughout the spray pyrolysis technique so that the final alloyed material will retain the initial stoichiometric ratio, thus allowing for the design and production of a catalytic material having a very specific predetermined ratio of one metal to another. The dissolved multi-metallic solution is them atomized and pyrolyzed resulting in a plurality of oxide particles. The particles are then dried to produce an oxide powder. The oxide powder is then reduced to metallic form to yield a catalytic solid solution consisting essentially of the alloyed metals.

Another advantage of the presently described method is that while previously described techniques produced catalysts that are ill-defined and wherein much less than 90% of the endproduct comprises the catalytic material, the presently described methodology produces catalysts that are phase pure, which leads to dramatically improved performance.

According to an embodiment, the spray pyrolysis method described herein results in the generation of particles with a homogenous composition. Accordingly, catalysts formed from greater than 90% catalytic material can easily be formed. Furthermore, the technique allows for the formation of catalysts composed of greater than 95%, and greater than 99.9% catalytic material. Typically, the particles are spherical in shape and composed of sintered agglomerated 20-60 nm crystallites, however it is possible to change and tailor the crystallite and agglomerate sizes.

According to various embodiments suitable oxophilic metals include zinc, copper, iron, manganese, gallium, cobalt, Manganese, Chromium, Vanadium, Titanium, and Scandium. Suitable electro-oxidative metals may include Nickel, Palladium, Platinum, Rhodium, Iridium, osmium, Rhenium, Ruthenium, Gold and Silver.

According to a specific embodiment, the catalytic material is a NiZn alloy. NiZn, like most catalysts, can be used to oxidize a variety of targets. For example, NiZn catalysts can oxidize both hydrazine and ethanol. As stated above, by utilizing the spray pyrolysis technique, the resulting catalytic material can be designed to have a predetermined stoichiometric composition. Accordingly, it may be desirable to produce a catalytic material having a desired stoichiometric composition in order to achieve a desired catalytic activity. Accordingly, depending on the target to be oxidized, the catalyst of the present disclosure may be designed to have a specific ratio of oxophilic metal to electro-oxidative metal. For example, as shown in the experiments section below, it was determined that NiZn alloys having a stoichiometric ratio of less than or equal to 27 atomic percent zinc had significantly higher catalytic activity for hydrazine than NiZn alloys having greater than 27 atomic percent zinc. Accordingly, it may be desirable to produce NiZn catalysts having less than or equal to 27 atomic percent zinc. Furthermore, it has been determined that NiZn alloys that are essentially 13 atomic percent zinc appear to have the greatest catalytic activity. Accordingly, it may be desirable to produce NiZn catalysts that are between 5 and 20% zinc, between 10 and 16% zinc, or that are essentially 13% zinc. According to an embodiment, the NiZn alloy may have a minimum metallic surface area of 1 m²/g. According to another embodiment, the NiZn alloy may have an onset potential for hydrazine oxidation in 1M KOH 1600 rpm in deoxygenated solution more negative than −1.03 V vs Hg/HgO reference electrode. The NiZn alloy may have an onset potential for ethanol oxidation in 1M KOH 1600 rpm in deoxygenated solution more negative than 0.4 V vs Hg/HgO reference electrode.

According to another specific embodiment, the catalytic material is a PdZn alloy. An exemplary PdZn catalytic material may have a stoichiometric ratio of Pd to Zn so that a so-called intermetallic L1o phase is formed; both the phase and composition affect catalyst performance. Alternatively, other compositions, such as those corresponding to the so called alpha phase with less than 20 at % Zn are also active and are advantageous for different operational requirements.

It should be appreciated that while the compositions of matter described herein are described as being catalysts due to their catalytic activity, they may be used for other purposes as well. For example, the ability of the NiZn material described herein to react with hydrazine may be exploited for use as a sensor for hydrazine detection. Furthermore, because the reaction of NiZn with hydrazine results in non-toxic products, the NiZn material described herein can be used to scrub hydrazine from systems that produce hydrazine as an unwanted by-product. Similarly, NiZn and PdZn can be used in ethanol sensors or to scrub ethanol.

The specific methods and compositions described herein are representative of preferred embodiments and are exemplary and not intended as limitations on the scope of the invention. Other objects, aspects, and embodiments will occur to those skilled in the art upon consideration of this specification, and are encompassed within the spirit of the invention as defined by the scope of the claims. It will be readily apparent to one skilled in the art that varying substitutions and modifications may be made to the invention disclosed herein without departing from the scope and spirit of the invention. The invention illustratively described herein suitably may be practiced in the absence of any element or elements, or limitation or limitations, which is not specifically disclosed herein as essential. The methods and processes illustratively described herein suitably may be practiced in differing orders of steps, and that they are not necessarily restricted to the orders of steps indicated herein or in the claims. As used herein and in the appended claims, the singular forms “a,” “an,” and “the” include plural reference unless the context clearly dictates otherwise.

Under no circumstances may the patent be interpreted to be limited to the specific examples or embodiments or methods specifically disclosed herein. Under no circumstances may the patent be interpreted to be limited by any statement made by any Examiner or any other official or employee of the Patent and Trademark Office unless such statement is specifically and without qualification or reservation expressly adopted in a responsive writing by Applicants.

The terms and expressions that have been employed are used as terms of description and not of limitation, and there is no intent in the use of such terms and expressions to exclude any equivalent of the features shown and described or portions thereof, but it is recognized that various modifications are possible within the scope of the invention as claimed. Thus, it will be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

All patents and publications referenced below and/or mentioned herein are indicative of the levels of skill of those skilled in the art to which the invention pertains, and each such referenced patent or publication is hereby incorporated by reference to the same extent as if it had been incorporated by reference in its entirety individually or set forth herein in its entirety. Applicants reserve the right to physically incorporate into this specification any and all materials and information from any such cited patents or publications.

### EXAMPLES

### Example I

### NiZn Catalyst

Electrocatalyst Synthesis

Synthesis of unsupported bimetallic NiZn and PdZn alloys and solid solutions was achieved using spray pyrolysis (see FIG. 1). Ni and Zn nitrates (99.999%, Sigma-Aldrich Co.) were dissolved in 10% HNO₃ to a final concentration of 5 wt % to specific stoichiometric ratios. The dissolved bimetallic solution was ultrasonically atomized and pyrolyzed in a quartz tube (1 in. OD, 24 in. long) in a furnace operating at 500° C. using N₂ (1 L/min) as the carrier gas. Pyrolyzed particles were air dried and collected on a Teflon filter. Alloys and solid solutions were formed by reduction of the oxide powders under flowing 5% H₂ in N₂ at 500° C. for 4 hrs. Several different stoichiometric compositions of Ni and Zn including, Ni_{0.87}Zn_{0.13}, Ni_{0.80}Zn_{0.20}, Ni_{0.50}Zn_{0.50}, and Ni_{0.33}Zn_{0.66}, were synthesized. Several different stoichiometric compositions of Pd and Zn were synthesized including those containing 2, 7, 12, 56, 54, 52, 50, 49 at % Zn and the remainder Pd.

Structural and Compositional Characterization

After reduction, phase purity, morphology, and composition of synthesized powders were characterized using X-Ray Diffraction (XRD), Scanning Electron Microscopy (SEM), Transmission Electron Microscopy (TEM), and Energy Dispersion Spectroscopy (EDS). X-ray powder diffraction spectra were recorded using a Scintag Pad V diffractometer with DataScan 4 software (MDI, Inc.) for system automation and data collection. Cu Ka radiation (40 kV, 35 mA) was used with a Bicron Scintillation detector (with a pyrolitic graphite curved crystal monochromator). Data sets were analyzed with Jade 9.5 Software (MDI, Inc.) using the ICDD (International Center for Diffraction Data) PDF2 database (rev. 2004) for phase identification.

Scanning electron microscopy (SEM) was performed on a Hitachi S-5200, with a resolution of 0.5 nm at 30 kV and 1.7 nm at 1 kV, equipped with PGT EDS. Transmission electron microscopy (TEM) was performed on a JEOL 2010F FASTEM field emission gun scanning transmission electron microscope equipped with Oxford EDS. The probe size was 1.0 nm, and accelerating voltage was 200 kV.

Electrochemical Measurements

An aqueous suspension (4 mg/mL in THF:1-Propanol, 1:4) of each powder was prepared and sonicated to disperse the powder in solution. A 2 wt % anion ionomer solution (A3, Tokuyama Corp.) was added to the suspension to act as a binder. 3 μl aliquots of the aqueous suspension were deposited onto a glassy carbon rotating-disc electrode (RDE) and allowed to air dry. Electrochemical measurements were conducted in a jacketed electrochemical cell containing 1M KOH at 60° C.

Hydrazine hydrate (24-26% in H2O, Sigma-Aldrich Co.) was dissolved to 5 wt % or Ethanol was dissolved to 1M in 1M KOH to perform cyclic voltammetry measurements. Potential sweep was scanned at 20 mV/s. A Pt-coil was used as a counter electrode and a Hg/HgO electrode (XR440, Radiometer Analytical SAS) was used as reference electrode. Before each experiment, the electrolyte solution was deoxygenated by bubbling Ar gas for at least 15 minutes prior to taking any measurements.

Computational

We augmented our experiments with calculations that are based on density-functional-theory using the plane wave software package VASP. See e.g., P. Hohenberg et al., “Inhomogeneous Electron Gas,” Physical Review B 136 (3B), B864-& (1964); G. Kresse et al., “Efficiency of ab-initio total energy calculations for metals and semiconductors using a plane-wave basis set,” Comp Mater Sci 6 (1), 15-50 (1996); G. Kresse et al., “Ab-Initio Molecular-Dynamics for Open-Shell Transition-Metals,” Physical Review B 48 (17), 13115-13118 (1993); G. Kresse et al., “Norm-Conserving and Ultrasoft Pseudopotentials for First-Row and Transition-Elements,” J Phys-Condens Mat 6 (40), 8245-8257 (1994); G. Kresse et al., “Efficient iterative schemes for ab initio total-energy calculations using a plane-wave basis set,” Physical Review B 54 (16), 11169-11186 (1996). Computational parameters are similar to those in previous computational studies on transition metal surface. See e.g., Chen et al, “Surface structure and stability of PdZn and PtZn alloys: Density-functional slab model studies,” Physical Review B 68 (7),-(2003); and Abild-Pedersen et al., “CO absorption energies on metals with correction for high coordination adsorption sites—A density functional theory study,” Surface Science 601 (7), 1747-1753 (2007). Electronic exchange and correlation effects were treated at the GGA level in the parametrization of Perdew, Burke, and Ernzerhof (see Perdew et al., “Generalized gradient approximation made simple,” Physical Review Letters 77 (18), 3865-3868 (1996)) and interactions between electrons and nuclei were described within the PAW formalism. See e.g., P. E. Blochl, “Projector Augmented-Wave Method,” Physical Review B 50 (24), 17953-17979 (1994); Kresse et al., “From ultrasoft pseudopotentials to the projector augmented-wave method,” Physical Review B 59 (3), 1758-1775 (1999). Electronic reference configurations (core radii in atomic units are given in parenthesis) were 3d⁸4p⁶4s2 (2.000 aB), 3d¹⁰4s² (2.300 aB), 2s²2p³ (1.850 aB), 1s¹ (1.100 aB), for Ni, Zn, N, and H, respectively. The electronic band-structure was computed on a F-centered 2×2×1 k-point grid. All calculations were performed using periodic boundary conditions and a plane wave energy cutoff of E_{cut}=400 eV. The Ni(111) and NiZn(111) surfaces were modeled as four layer slabs (64 atoms), the initial atomic positions were derived from the DFT optimized bulk structures. The NiZn(111) surface was derived from the stable L1₀ phase of Ni₁₋ₓZnₓ which is stable between x_{Zn}˜44 and 52 at %. See e.g., H. Okamoto, “Ni—Zn (Nickel-Zinc),” Journal of Phase Equilibria 24, 280-281 (2003). The atoms in the bottom two layers were held fixed at the DFT optimized bulk equilibrium positions while the atoms in the top two layers and adsorbed hydrazine were allowed to fully relax, similar to previous work on the L1⁰ phase of PdZn. See e.g., Abild-Pedersen et al., “CO absorption energies on metals with correction for high coordination adsorption sites—A density functional theory study,” Surface Science 601 (7), 1747-1753 (2007). The calculated equilibrium lattice parameter for fcc-Ni is a=3.507 Å (14×14×14 k-point grid), for tetragonal, stoichiometric, ordered Ni0.50Zn0.50 in the tP4 setting we obtain, a=3.838 Å and c=3.264 Å (14×14×16 k-point grid), and recomputed for the standard setting, a_{L10}=b_{L10}=a_{tP4}/sqrt(2)=2.714, c_{L10}=c_{tP4}=3.264 Å. The DFT optimized lattice parameters compare favorably with experimental observations: a=3.517 Å(fcc-Ni), and a=2.7413 Å, and c=3.1719 Å(L1₀-Ni_{0.50}Zn_{0.50}). See e.g., W. B. Pearson, Handbook of Lattice Spacings and Structures of Metals. (Pergamon Press Ltd, 1967), 1 ed. Interactions due to the periodic boundary condition perpendicular to the slab were diminished by the insertion of a thick 14 Å vacuum layer and by introducing a compensating dipole layer. See, Makov et al., “Periodic Boundary-Conditions in Ab-Initio Calculations,” Physical Review B 51 (7), 4014-4022 (1995); Neugebauer et al., “Adsorbate-Substrate and Adsorbate-Adsorbate Interactions of Na and K Adlayers on Al(111),” Physical Review B 46 (24), 16067-16080 (1992). The Fermi-level was broadened using a 1st order Methfessel and Paxton smearing (σ=0.1 eV), see M. Methfessel et al., “High-Precision Sampling for Brillouin-Zone Integration in Metals,” Physical Review B 40 (6), 3616-3621 (1989). Molecular N2H4 was optimized prior to adsorption in the gas phase in an orthogonal anisotropic box of dimensions 16 Å15 Å×14 Å using a single k-point (F-point). Binding energies were evaluated from the internal energies as: EB=E(surface-N2H4)−E(surface)−E(N2H4). Zero point motion and thermal effects were neglected since they tend to compensate in the binding energy calculation especially at the low temperatures of interest in this study.

Electrocatalyst Characterization

The spray pyrolysis technique used to synthesize the bimetallic Ni alloys and solid solutions offers the advantage of generating particles with homogeneous compositions, allowing the formation of particles with the same composition as the starting liquid precursor. The SEM micrographs illustrates the characteristic spherical shaped particles composed of sintered agglomerated 20-60 nm crystallites obtained after pyrolysis and reduction conditions (FIG. 2).

SEM/EDS was used to characterize the composition of the bulk NiZn alloys (Table 1). Homogeneity of the composition of synthesized Ni alloys was observed by comparing the expected and final compositions of the materials.

TABLE I
SEM/EDS composition of Ni₁₋ₓZnₓ

| Catalyst | Atomic % Ni | Atomic % Zn |
|---|---|---|
| Ni_{0.33}Zn_{0.66} | 34 ± 3 | 66 ± 3 |
| Ni_{0.50}Zn_{0.50} | 49 ± 3 | 51 ± 3 |
| Ni_{0.80}Zn_{0.20} | 79 ± 1 | 21 ± 1 |
| Ni_{0.87}Zn_{0.13} | 89 ± 1 | 11 ± 1 |

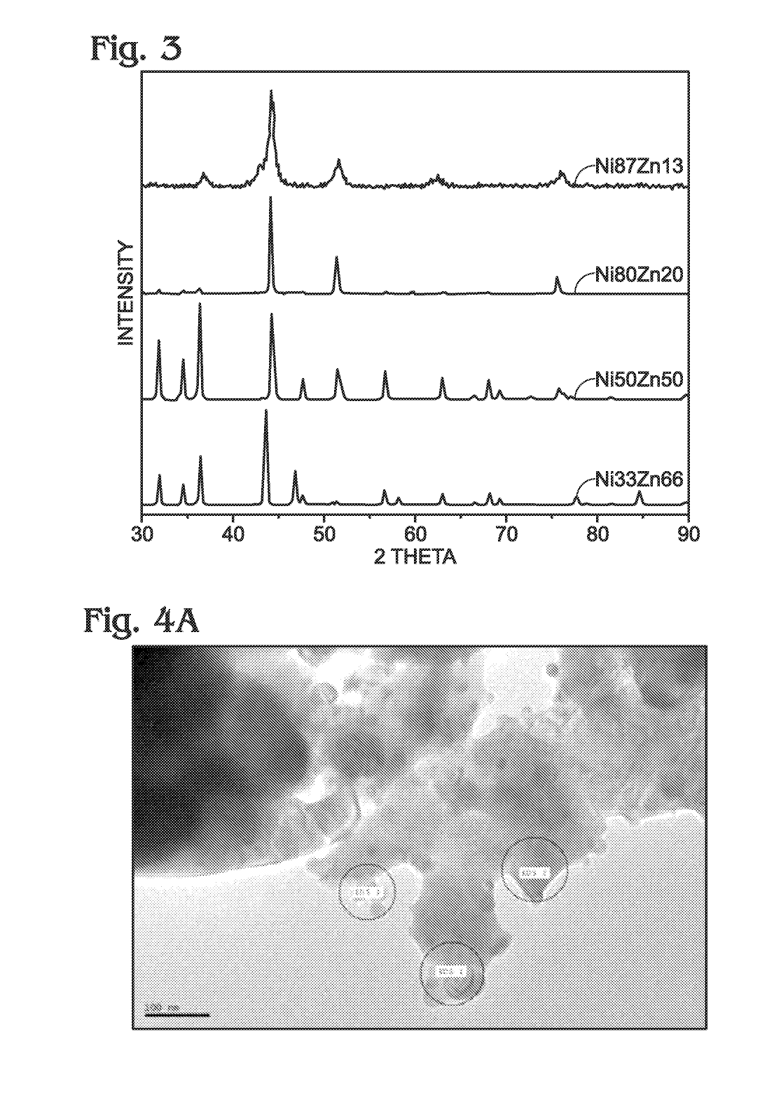

XRD diagrams for the different NiZn solid solutions are shown in FIG. 3. According to the NiZn phase diagram, a Ni-like FCC solid solution (a-phase) is expected for the Ni_{0.87}Zn_{0.13} and Ni_{0.80}Zn_{0.20} compositions. FCC characteristic peaks for these two catalysts are observed at 2θ angles at 44.1°, 51.3°, and 75.5°, which correspond to the (111), (200), and (220) planes respectively. A single-phase bimetallic alloy (β1-phase) with a tetragonal crystal structure is expected for the Ni_{0.50}Zn_{0.50} composition. Additionally, Ni_{0.33}Zn_{0.66} should be a mixture of the β1 structure plus a cubic (γ-phase) structure. Ni_{0.50}Zn_{0.50} and Ni_{0.33}Zn_{0.66} diagrams display a more complex spectrum compared to those of Ni_{0.87}Zn_{0.13} and Ni_{0.80}Zn_{0.20}. Both of these catalysts contain characteristic peaks at 2θ angles 32°, 34.5°, and 36°. These peaks are representative of the (100), (002), and (101) planes in ZnO. In addition to the presence of ZnO, Ni_{0.50}Zn_{0.50} also displays peaks for the Ni-like structure. The only catalyst displaying peaks characteristic of the β1 phase is Ni_{0.33}Zn_{0.66}. These peaks are observed at 2θ angles of 44.5° and 47°. Scherrer analysis of all materials yields average crystallite sizes of 21±5 nm. XRD of the PdZn synthesized is in FIG. 8, illustrating the formation of PdZn beta phase, alpha phase, and beta+ZnO.

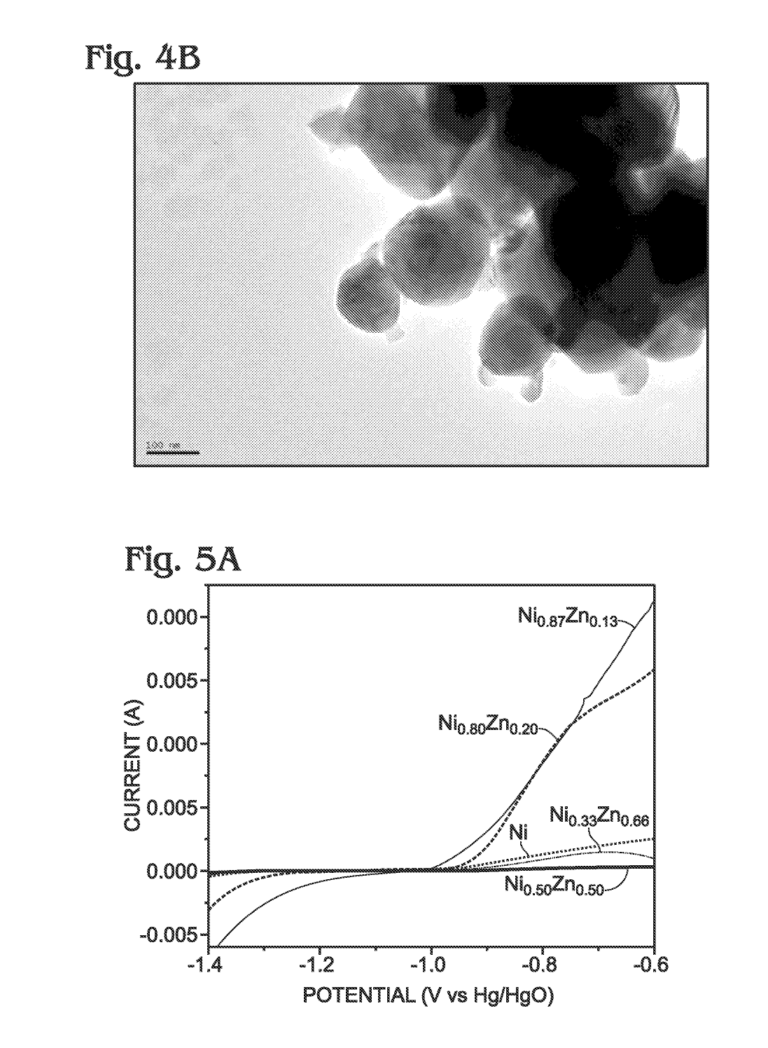

Transmission Electron Microscopy (TEM) micrographs of Ni_{0.80}Zn_{0.20} and Ni_{0.50}Zn_{0.50} are shown in FIG. 4. The Ni_{0.80}Zn_{0.20} catalyst is composed of dense rounded particles, consistent with the homogeneously metallic nature of the catalyst predicted by the phase diagram and confirmed by XRD. The Ni_{0.50}Zn_{0.50} catalyst shows the presence of a matrix supporting a number of denser smaller particles. TEM/EDS were used to confirm the composition of the matrix and supported particles. Table 2 below shows the EDS analysis of the composition of the supporting matrix of the Ni_{0.50}Zn_{0.50} catalyst (Rightmost circle of the left TEM micrograph of FIG. 4). The atomic composition in Table 2, where the matrix is composed of Zn with trace Ni, suggests that the matrix is composed of ZnO. The 2% atomic Ni is most likely attributed to some nanoparticles supported on the matrix. TEM/EDS analysis for area including particles supported on the ZnO matrix is summarized in Table 3. For both areas Ni is the most prevalent element present, with smaller amounts of Zn also indicated. It is likely that much of the detected Zn is due to the surrounding matrix. Consideration of the NiZn phase diagram as well as XRD results suggest that the supported particles are Ni with as much as 20 wt % Zn dissolved in the Ni. The tetragonal NiZn phase expected for Ni_{0.50}Zn_{0.50} was not observed. The Ni_{0.50}Zn_{0.50} catalyst is therefore a ZnO matrix supporting a number of smaller denser NiZn particles, confirming the multi-phasic composition measured by XRD.

TABLE II
EDS analysis of supporting matrix of Ni_{0.50}Zn_{0.50} catalyst.

| Element | Weight % | Atomic % |
|---|---|---|
| Ni K | 4.86 | 5.39 |
| Zn K | 95.14 | 94.61 |

TABLE III
EDS analysis of two supported particles of the Ni_{0.50}Zn_{0.50} catalyst.

| | | |
|---|---|---|
| Element | Weight % | Atomic % |

Particle 1

| | | |
|---|---|---|
| Ni K | 83.92 | 85.32 |
| Zn K | 16.08 | 14.68 |

Particle 2

| | | |
|---|---|---|
| Ni K | 63.78 | 66.23 |
| Zn K | 36.22 | 33.77 |

Characterization of these synthesized particles therefore shows that Ni_{0.87}Zn_{0.13} and Ni_{0.80}Zn_{0.20} are FCC solid solutions of Zn in Ni as expected, while the Ni_{0.50}Zn_{0.50} and Ni_{0.33}Zn_{0.66} catalysts are multiphasic containing ZnO, as well as NiZn. For Ni_{0.50}Zn_{0.50} the NiZn is a solid solution of ˜20 at % Zn in Nickel, while Ni_{0.33}Zn_{0.66} contains both a solid solution of Zn in Ni and the expected β1 tetragonal NiZn phase.

These synthesized bimetallic Ni compounds were tested as electrocatalysts for the anodic oxidation of hydrazine. In alkaline media, the electrochemical oxidation of hydrazine occurs according to the following reactions:

N₂H₄+4OH—→N₂+4H₂O+4e- [1]

N₂H₄+3OH—→N₂+½H₂+3H₂O+3e- [2]

N₂H₄+2OH—→N₂+H₂+2H₂O+2e- [3]

N₂H₄+OH—→N₂+(3/2)H₂+H₂O+e- [4]

N₂H₄+OH—→½N₂+NH₃+H₂O+e- [5]

Of these, the most desirable reaction is the 4-electron reaction [1]. Initial calculations assumed that the N—N bond in hydrazine is parallel to the surface. We performed a linear interpolation between the DFT optimized surface geometries of the Ni(111) and NiZn(111) alloy surfaces to best match the optimized geometry of hydrazine. The result predicted that an optimal composition of approximately Ni_{0.87}Zn_{0.13}, in excellent agreement with the electrochemical performance experiments. Further DFT evaluation showed that the interaction between hydrazine and surfaces depends strongly on composition. Hydrazine is predicted to decompose on Ni(111) to form two NH₂ fragments with a combined binding energy of EB=1.5 eV. In contrast, hydrazine remains molecular on Ni_{0.50}Zn_{0.50} with the lone pair pointing toward Ni and filling the Ni 3d shell. The binding energy of hydrazine to Ni in the presence of Zn is much lower, EB=0.8 eV. These results indicate that the contribution of Zn is to both stabilize molecular hydrazine and to reduce its binding energy such that it can be oxidized in an alkaline environment.

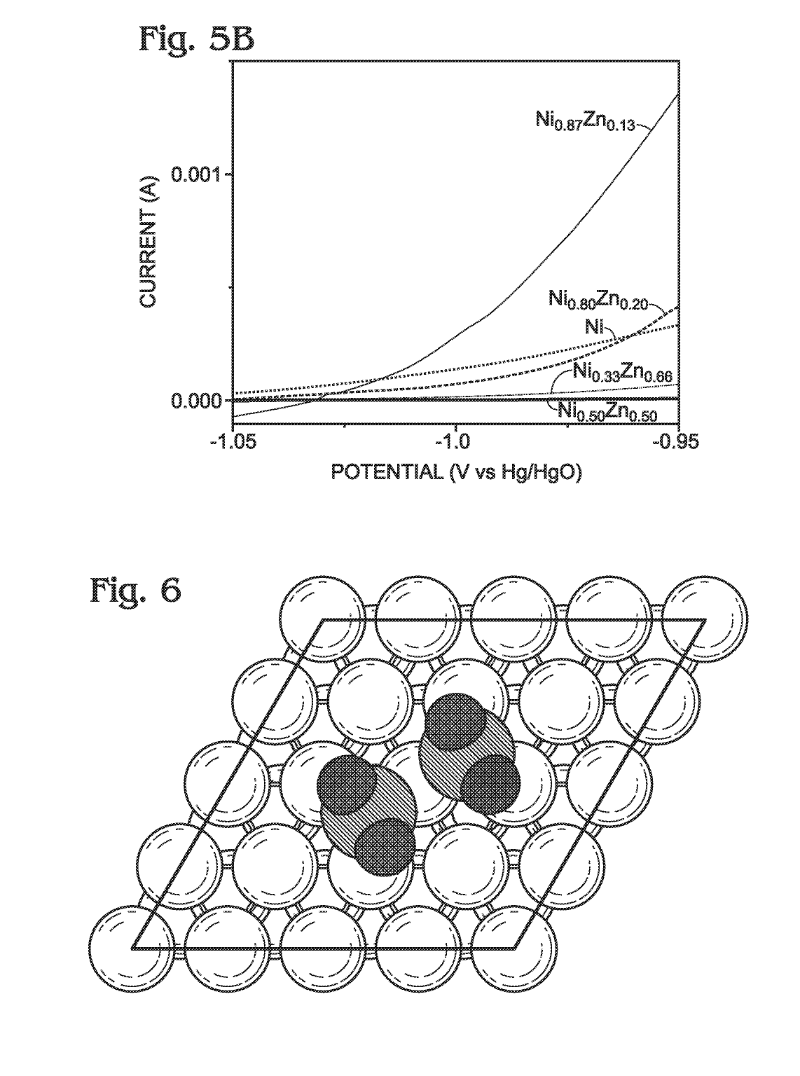

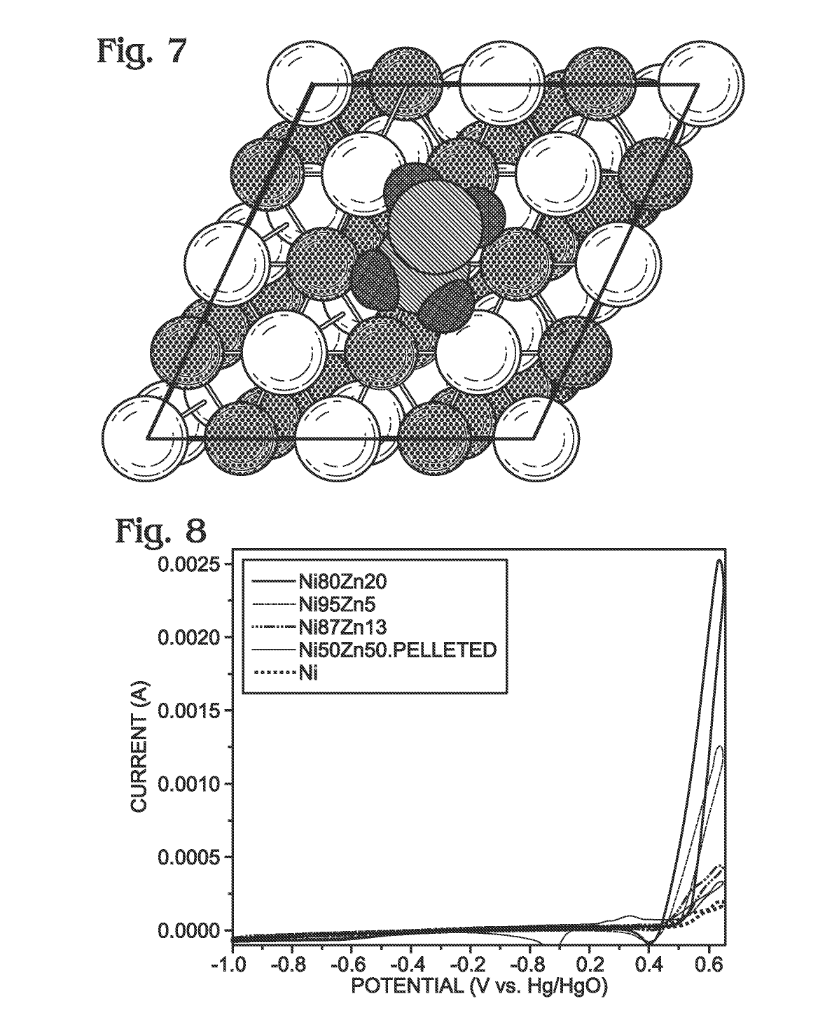

The electrochemical performance of the synthesized Ni solid solutions is shown below in FIG. 5. The RDE data shows similar onset potentials for the Ni and Ni solid solutions. The onset potentials range from −0.95 to −1.05 (V vs. Hg/HgO). Mass activity was found to be highest for the Ni_{0.87}Zn_{0.13} bimetallic catalyst with 1.7 A/gcat, Ni_{0.50}Zn_{0.50} showed the lowest mass activity among the catalysts tested. However, recalling that the characterization of the Ni_{0.50}Zn_{0.50} catalyst showed a catalyst composed of a ZnO matrix supporting smaller NiZn particles, the activity seen here is only due to those supported nanoparticles and thus cannot be accurately compared in terms of amount of active Ni catalyst present.

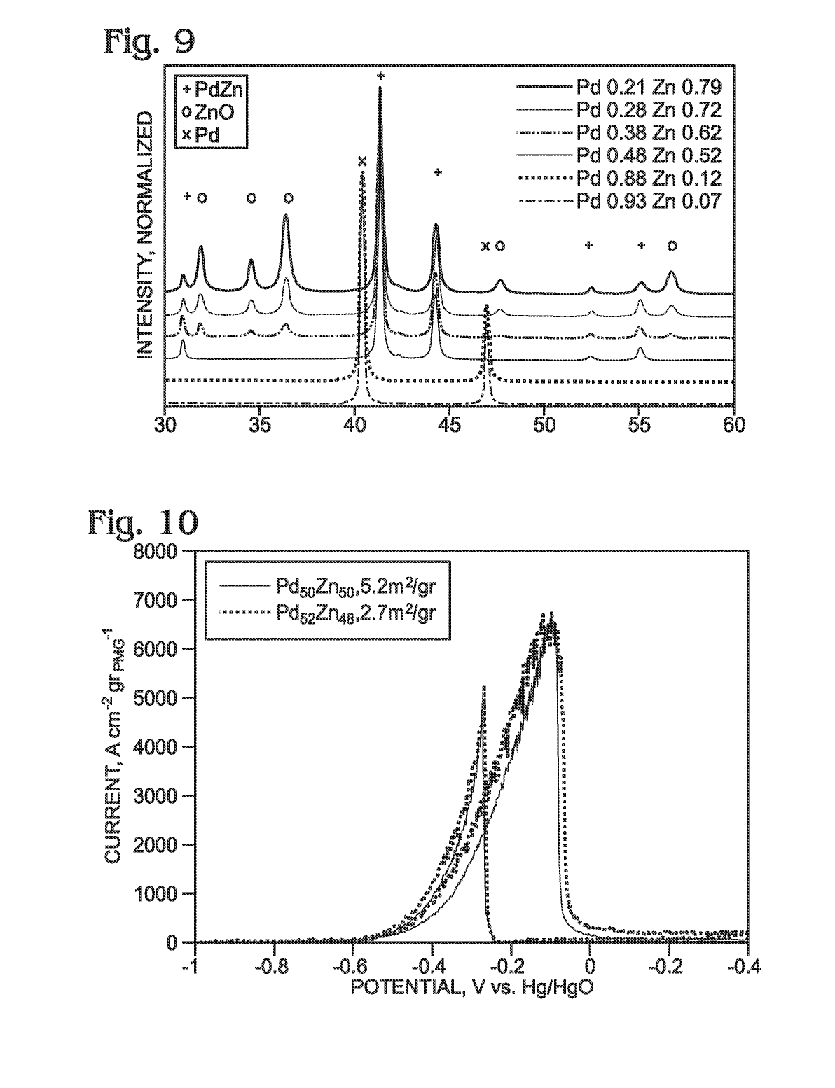

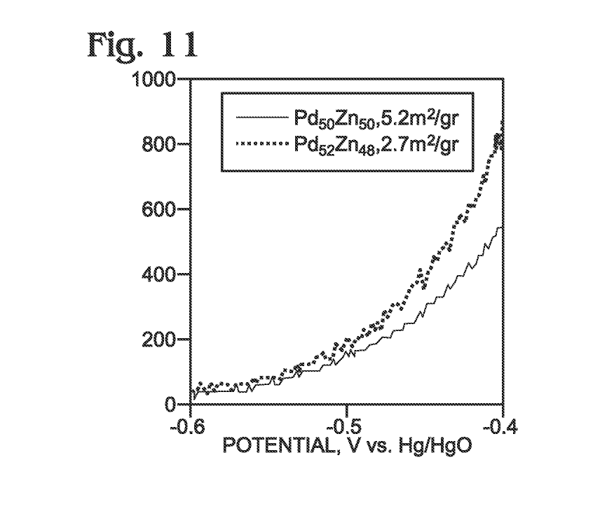

The electrochemical performance of the NiZn and PdZn for ethanol electrooxidation in alkaline media is illustrated in FIGS. 8-11, demonstrating onset potentials of −0.6 and 0.0 for PdZn and NiZn, respectively. Onset potentials and maximum performance are affected by chemical composition and phase.

What is claimed is:

1. A catalytic material wherein greater than 90% of the material consists of a homogenous solid solution form of sintered crystallites of an alloy of an oxophilic material and an electro-oxidative metal.

2. The catalytic material of claim 1 wherein the electro-oxidative metal is nickel.

3. The catalytic material of claim 1 wherein the electro-oxidative metal is palladium.

4. The catalytic material of claim 1 wherein the oxophilic material is zinc.

5. The catalytic material of claim 2 wherein the oxophilic material is zinc.

6. The catalytic material of claim 5, wherein the catalytic material is greater than 0 and less than or equal to 27 atomic weight percent zinc.

7. The catalytic material of claim 5 wherein the atomic percentage of the zinc is between 10 and 16 percent.

8. The catalytic material of claim 5 wherein the atomic percentage of oxophilic is approximately 13 percent.

9. The catalytic material of claim 1 wherein the catalytic activity of the catalytic material is higher than the catalytic material of the electro-oxidative metal alone.

10. The catalytic material of claim 5 wherein the minimum metallic surface area of the material is 1 m²/g.

11. The catalytic material of claim 5 having an onset potential for hydrazine oxidation in 1M KOH 1600 rpm in deoxygenated solution more negative than −1.03V vs. Hg/hgO reference electric.

12. The catalytic material of claim 5 wherein the minimum metallic surface area of the material is 1 m²/g.

13. A method for forming a catalytic material comprising:
atomizing a solution containing dissolved metal and zinc nitrates, wherein the metal formed from the metal nitrate has oxidative activity;
pyrolyzing the solution to produce oxide particles;
drying the oxide particles to produce an oxide powder; and
reducing the powder to produce a homogenous Zn-alloy solid solution.

14. The method of claim 13 wherein the stoichiometric ratio of nickel to zinc is between 78:22 and 95:5.

15. The method of claim 13 wherein the stoichiometric ratio of nickel to zinc is between 84:16 and 90:10.

16. The method of claim 13 wherein the stoichiometric ratio of nickel to zinc is essentially 87:13.

17. The method of claim 13 wherein the minimum metallic surface area of the NiZn solid solution is 1 m²/g.

18. The method of claim 13 wherein the NiZn solid solution has an onset potential for hydrazine oxidation in 1M KOH 1600 rpm in deoxygenated solution more negative than −1.03V vs. Hg/HgO reference electric.

19. A method for detecting hydrazine in a system comprising:
providing a hydrazine detecting material wherein greater than 90% of the material consists of a solid solution of zinc and nickel that is greater than 0 and less than or equal to 27 atomic weight percent zinc and less than 100 and greater than 83 atomic percent nickel;
exposing the hydrazine detecting material to the system; and
determining whether the hydrazine detecting material has undergone a chemical reaction.

20. The method of claim 19 further comprising;
allowing the hydrazine detecting material to continue to react with the hydrazine in the system in order to remove the hydrazine from the system.
